(19) United States
(12) Patent Application Publication
(10) Pub. No.: US 2005/0135228 A1
(43) Pub. Date: Jun. 23, 2005

(54) Film structure of a rewritable compact disc

(76) Inventors: Wu Hsuan Ho, Hsinchu (TW); Yi-Chen Chung, Hsinchu (TW); Shih Hsiang Chou, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/739,161

(22) Filed: Dec. 19, 2003

(51) Int. Cl. G11B 7/24

(52) U.S. Cl. 369/275.5; 430/270.13; 430/945; 428/64.5; 369/275.2

(57) ABSTRACT

The present invention discloses a film structure of a rewritable compact disc including a transparent substrate on which sequentially laminated a phase-change recording layer, a dielectric layer and a reflective layer; and a barrier layer located between the dielectric layer and the reflective layer to insulate the dielectric layer and the reflective layer, and the feature of the barrier layer is that the barrier layer is composed of a germanium compound. The present invention provides an easily controlled process of the film structure, which can effectively improve the weather-resistibility of the disc to extend the lifetime and the conserving time of the disc.

### BACKGROUND OF INVENTION

1. Field of the Invention

The invention relates to a rewritable compact disc, and more particularly, to a weather-resistant film structure of a rewritable compact disc.

2. Description of the Prior Art

As the development of the digital multimedia, the 650 MB CD-ROM that can store the audio and video data in 74 minutes is insufficient for the requirement of the video quality and the capacity. The digital versatile disk (DVD) is developed to satisfy the large capacity required by the high quality video and the digital AV multimedia.

For providing the DVD disc with a compatible characteristic to the CD disc, the DVD disc has a 12 cm diameter and is constructed with two 0.6 mm substrates. The film structure of a conventional DVD is shown in FIG. 1, that the upper and lower transparent substrates 10, 10′ are bonded with a bonding layer 12 to be a data surface and a label printed surface respectively. On the lower surface of the upper transparent substrate 10, there are sequentially a dielectric layer 13, a recording layer 14, a dielectric layer 16, a barrier layer 18 and a reflective layer 20. The recording layer 14 is a phase-change layer utilizing the thermal energy of the laser in different intensity to heat the recording layer 14, and transforming the recording layer 14 between the crystal phase and the amorphous phase. Since the reflectivity of the crystal phase is 10%-30% higher than that of the amorphous phase, the recorded data can be read out. The material of the dielectric layer 16 and the reflective layer 20 are generally ZnS—SiO₂ and Ag alloy respectively, and the barrier layer 18 is utilized to be an insulating layer to prevent the sulfur in the dielectric layer 16 from reacting with the Ag in the reflective layer 20.

However, in the film structure of the conventional DVD, the material of the barrier layer 18 is generally Si or its compound, such as SiN, SiC and so on. The sputtering process with Si or Si compound target is utilized to form the barrier layer 18. This kind of sputtering compound is very sensitive, and the weather-resistibility is affected with a small process variation. The sputtering process is unstable and usually causes the deterioration to affect the weather-resistibility of the disc. Hence, the present invention discloses a film structure of a rewritable compact disc to overcome the above-mentioned disadvantages.

### SUMMARY OF INVENTION

It is therefore a primary objective of the claimed invention to provide a film structure of a rewritable compact disc, which disusing the conventional Si compound barrier layer and using the germanium (Ge) compound instead. The process of the film structure is easily controlled, and the stability is effectively improved. The barrier layer is not easy to deteriorate and has a better barrier result to effectively overcome the unstability of the prior art.

It is therefore another objective of the claimed invention to provide a film structure of a rewritable compact disc, which can effectively improve the weather-resistibility of the disc to extend the lifetime and the conserving time of the disc.

According to the claimed invention, a film structure of a rewritable compact disc includes a transparent substrate on which sequentially laminated a phase-change recording layer, a dielectric layer and a reflective layer; and a germanium compound barrier layer located between the dielectric layer and the reflective layer to insulate the dielectric layer and the reflective layer.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a cross-sectional view of a rewritable compact disc according to the prior art.

FIGS. 2-4 are cross-sectional views of a rewritable compact disc according to the present invention.

FIG. 5 is an inspection data of the weather-resistibility according to the present invention.

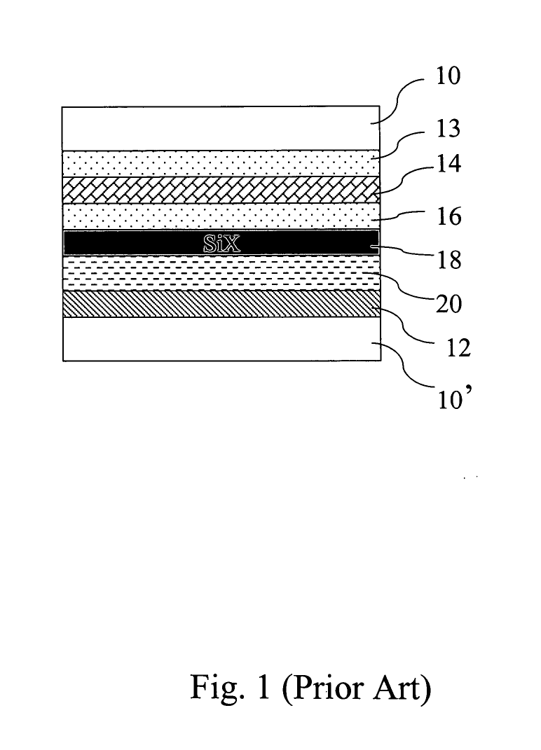

| | |
|---|---|
| 10 | upper transparent substrate |
| 10′ | lower transparent substrate |
| 12 | bonding layer |
| 14 | recording layer |
| 16 | dielectric layer |
| 18 | barrier layer |
| 20 | reflective layer |
| 30 | upper transparent substrate |
| 30′ | lower transparent substrate |
| 32 | bonding layer |
| 34 | dielectric layer |
| 36 | phase-change recording layer |
| 38 | dielectric layer |
| 40 | barrier layer |
| 42 | reflective layer |

### DETAILED DESCRIPTION

The present invent relates to a barrier layer in the film structure of the compact disc, and the feature is that the barrier layer is composed of a germanium compound to improve the process stability and the weather-resistibility.

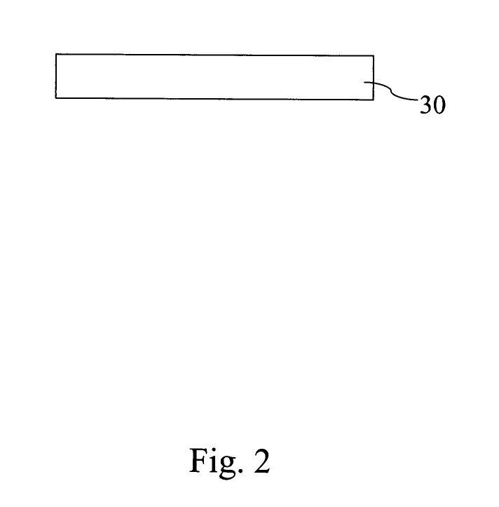

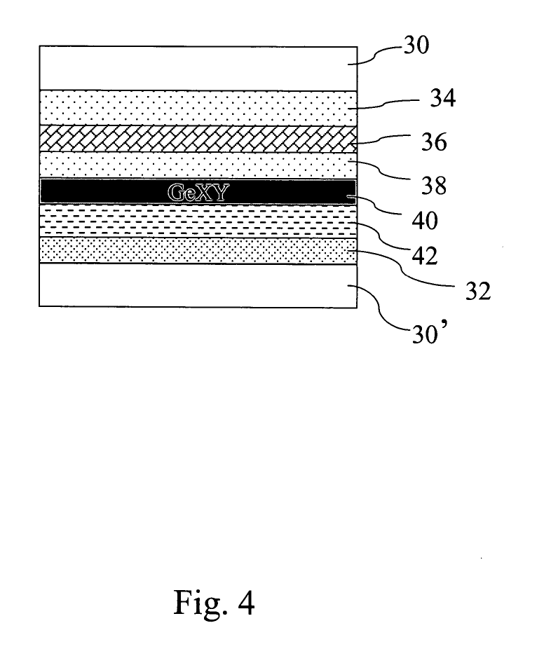

FIGS. 2 to 4 are cross-sectional views of a rewritable compact disc according to the present invention. Please refer to FIG. 4, which is a cross-sectional view of the present invention. The rewirtable compact disc includes upper and lower transparent substrates 30, 30′ bonded with a bonding layer 32. The upper transparent substrate 30 is a data area and the lower transparent substrate 30′ is a label printed area. On the lower surface of the upper transparent substrate 30, there are sequentially a dielectric layer 34, a phase-change recording layer 36, a dielectric layer 38, a barrier layer 40 and a reflective layer 42. The barrier layer 40 is used for insulating the dielectric layer 34 and the reflective layer 42, and the barrier layer 40 is composed of a germanium compound.

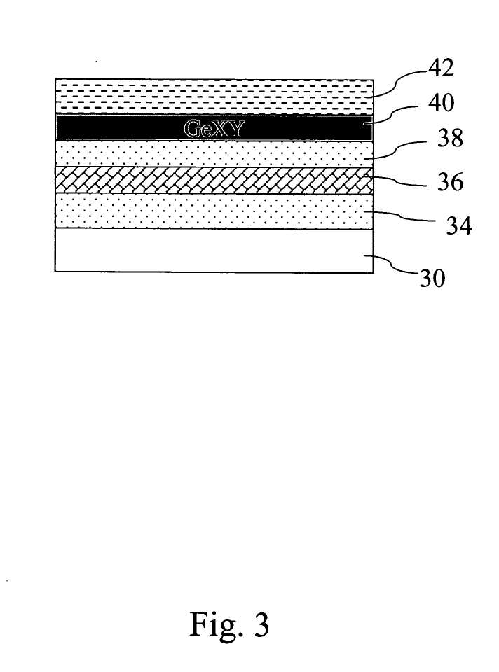

After explaining the entire structure, the structure and manufacturing method of each layer will be described following. Please refer to FIGS. 2 to 4. Firstly, as shown in FIG. 2, the transparent substrate 30, which is made by plastic material with the injection molding method, is provided. The plastic material is generally the polycarbonate (PC), and the transparent substrate 30 is in a 0.6 mm thickness. Then, as shown in FIG. 3, with the sputtering method that the vacuum sputtering is commonly used, the dielectric layer 34, the phase-change recording layer 36, the dielectric layer 38, the barrier layer 40 and the reflective layer 42 are sequentially coated on the transparent substrate 30, and the semi-product of the disc is finished. The material of the dielectric layers 34, 38 is generally ZnS—SiO₂, and the phase-change recording layer 36 is composed of silver (Ag), indium (In), antimony (Sb) and tellurium (Te). When irradiated by the laser, the phase-change recording layer 36 is transformed between the crystal phase and the amorphous phase, and the 0 and 1 signals are distinguished in accordance with the high reflectivity of the crystal phase and the low reflectivity of the amorphous phase. The barrier layer 40 is composed of the germanium compound, and the germanium compound is generally GeN or GeCrN. The material of the reflective layer 42 is generally Ag or Ag alloy to reflect the laser signal.

After finishing the semi-product of the disc, as shown in FIG. 4, the lower transparent substrate 30′ is faced to the reflective layer 42 of the upper transparent substrate 30, and these two transparent substrates 30, 30′ are bonded together to be a DVD disc in a 1.2 mm thickness. The lower transparent substrate 30′ is also a transparent plastic substrate which is also commonly composed of polycarbonate, and the lower transparent substrate 30′ is printed a label.

Then, an initializing process of the DVD disc is performed to crystallize the phase-change recording layer 36. The DVD disc is finished.

In the above-mentioned structure, the barrier layer 40 is used for preventing the sulfur in the dielectric layer 38 from reacting with the Ag in the reflective layer 42. The prior art using the Si or the Si compound to be the target is unstable for sputtering process and usually causes the deterioration to affect the weather-resistibility of the disc. In the claimed invention, germanium (Ge) is utilized to be the main material of the target and effectively improves the process stability. The process is easy to control and the barrier layer has a better barrier result that can substantially enhance the weather-resistibility of the disc and improve the quality stability.

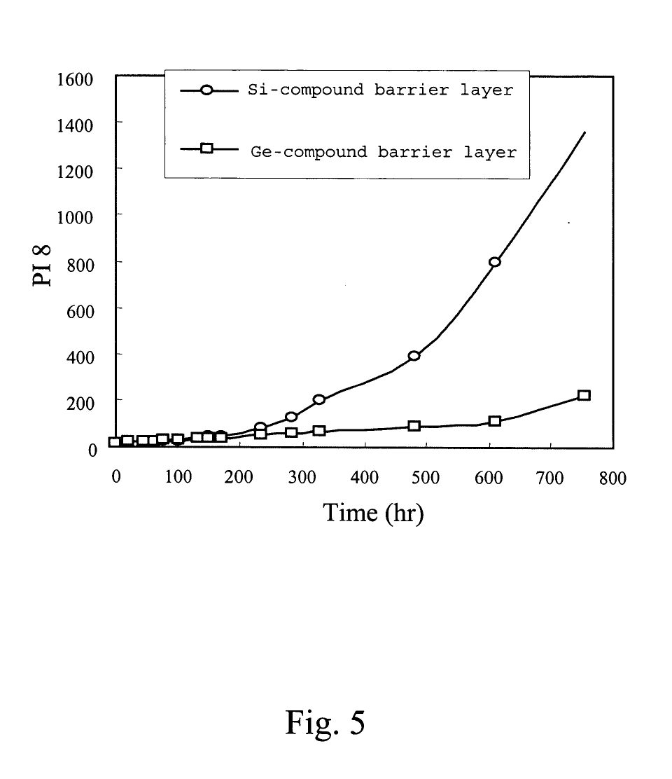

The claimed invention is verified in the aging test with the 80° C. temperature and the 85% relative humidity, and the specimens are the claimed disc with the Ge compound barrier layer and the conventional disc with the Si compound barrier layer. Table 1 is the test result, and the relative curve is shown in FIG. 5. In Table 1, PI8 is PI sum 8 that means the sum of the data error in 8 continuous blocks, and the larger number means the more mistakes (1 block=32 Kbyte). Jitter means the stability of the written mark position and length, and the smaller number means the more accurate result.

According to the inspection result, the weather-resistibility of the claimed disc is more than 700 hours, and that of the conventional disc is less than 50-300 hours. The weather-resistibility is obviously improved.

TABLE 1

| | PI8 | | Jitter | |
|---|---|---|---|---|
| Time | Si compound | Ge compound | Si compound | Ge compound |
| (hr) | barrier layer | barrier layer | barrier layer | barrier layer |

| | | | | |
|---|---|---|---|---|
| 0 | 15 | 12 | 8.3 | 8.9 |
| 22 | 22 | 20 | 9.2 | 9.0 |
| 44 | 21 | 25 | 8.9 | 9.6 |
| 62 | 22 | 25 | 9.3 | 9.7 |
| 78 | 21 | 27 | 9.0 | 9.6 |
| 102 | 26 | 31 | 9.3 | 9.6 |
| 134 | 33 | 34 | 9.5 | 9.7 |
| 150 | 44 | 35 | 9.8 | 9.5 |
| 170 | 45 | 40 | 9.2 | 9.4 |
| 235 | 84 | 51 | 9.7 | 9.5 |
| 283 | 123 | 59 | 9.4 | 9.5 |
| 327 | 198 | 67 | 9.8 | 9.4 |
| 482 | 389 | 91 | 10.4 | 9.4 |
| 610 | 798 | 112 | 12.6 | 10.1 |
| 755 | 1362 | 218 | 14.5 | 10.6 |

Hence, the barrier layer in the film structure of the rewritable compact disc of the claimed invention is altered from the Si compound to the Ge compound, and can effectively improve the process stability and the weather-resistibility of the disc to extend the lifetime and the conserving time of the disc.

Those skilled in the art will readily observe that numerous modifications and alterations of the device may be made while retaining the teachings of the invention. Accordingly, the above disclosure should be construed as limited only by the metes and bounds of the appended claims.

1. A film structure of a rewritable compact disc, comprising:
a transparent substrate on which sequentially laminated a phase-change recording layer, a dielectric layer and a reflective layer; and
a barrier layer located between the dielectric layer and the reflective layer to insulate the dielectric layer and the reflective layer, and the feature of the barrier layer is that the barrier layer is composed of a germanium compound.

2. The film structure of the rewritable compact disc of claim 1, wherein the germanium compound is selected from one of a GeN and a GeCrN material.

3. The film structure of the rewritable compact disc of claim 1, wherein a dielectric layer is further located between the transparent substrate and the phase-change recording layer.

4. The film structure of the rewritable compact disc of claim 1, wherein the material of the dielectric layer is ZnS—SiO₂.

5. The film structure of the rewritable compact disc of claim 1, wherein a label printed substrate is further located on the transparent substrate, and the transparent substrate and the label printed substrate is adhered by a bonding layer.

6. The film structure of the rewritable compact disc of claim 1, wherein the transparent layer is composed of a plastic material.

7. The film structure of the rewritable compact disc of claim 1, wherein the material of the transparent substrate is polycarbonate (PC).

8. The film structure of the rewritable compact disc of claim 1, wherein the phase-change recording layer is composed of silver (Ag), indium (In), antimony (Sb) and tellurium (Te).

9. The film structure of the rewritable compact disc of claim 1, wherein the material of the reflective layer is selected from one of Ag and Ag alloy.

10. The film structure of the rewritable compact disc of claim 1, wherein the phase-change recording layer, the dielectric layer, the barrier layer and a reflective layer are formed by a sputtering method.
